(19) United States
(12) Patent Application Publication
(10) Pub. No.: US 2024/0420656 A1
(43) Pub. Date: Dec. 19, 2024

(54) DISPLAY DRIVING METHOD, DISPLAY SUBSTRATE, AND DISPLAY DEVICE

(71) Applicant: BOE TECHNOLOGY GROUP CO., LTD., Beijing (CN)

(72) Inventors: Jiaqi Li, Beijing (CN); Zijiao Xue, Beijing (CN); Zhiqiang Wang, Beijing (CN); Wenhong Tian, Beijing (CN); Hao Zhang, Beijing (CN)

(73) Assignee: BOE TECHNOLOGY GROUP CO., LTD., Beijing (CN)

(21) Appl. No.: 18/704,196

(22) PCT Filed: Jul. 19, 2023
(86) PCT No.: PCT/CN2023/108125

§ 371 Date: Apr. 24, 2024

(30) Foreign Application Priority Data
Jul. 26, 2022 (CN) 202210883745.1

(51) Int. Cl. G09G 3/36; G09G 3/00

(52) U.S. Cl. CPC G09G 3/36; G09G 3/001; G09G 2310/0235; G09G 2310/0243; G09G 2310/0267

(57) ABSTRACT

A display driving method, a display substrate, and a display device are provided. The display driving method is applied to the display device, the display device includes a base substrate, a plurality of scan lines and a plurality of data lines arranged on the base substrate, the display substrate further includes a data chip, output terminals of data output channels of the data chip are connected to the data lines, and the data output channels are in one-to-one correspondence to the data lines. The method includes: receiving an image display instruction; and providing scan signals through the scan lines, and providing data signals to the data lines simultaneously through the data chip, wherein each data channel of the data chip provides a data signal to a corresponding data line.

### CROSS REFERENCE TO RELATED APPLICATIONS

This disclosure claims priority to Chinese patent application No. 202210883745.1 filed in China on Jul. 26, 2022, which is incorporated herein by reference in its entirety.

### TECHNICAL FIELD

Embodiments of the present disclosure relate to the technical field of thin film communications, and in particular, to a display driving method, a display substrate, and a display device.

### BACKGROUND

A liquid crystal display device (LCD) with field sequential display provides color through a backlight. When compared with a conventional LCD with a color filter, such an LCD has advantages such as a higher transmittance, low power consumption and the like since there is no need to provide a color filter therein.

### SUMMARY

Embodiments of the present disclosure provide a liquid crystal antenna control method and apparatus, a liquid crystal antenna system, an electronic device, and a readable storage medium.

In a first aspect, embodiments of the present disclosure provide a display driving method, applied to a display device, where the display device includes a base substrate, a plurality of scan lines and a plurality of data lines arranged on the base substrate; the display substrate further includes a data chip, output terminals of data output channels of the data chip are connected to the plurality of data lines, respectively, and the data output channels are in one-to-one correspondence to the plurality of data lines;
the method includes the following steps:
receiving an image display instruction; and
providing scan signals through the plurality of scan lines; and providing data signals to the plurality of data lines simultaneously through the data chip, where each of the data output channels of the data chip provides a data signal to a corresponding one of the plurality of data lines.

In some embodiments, the plurality of scan lines are divided into a plurality of groups along a direction for arranging the plurality of scan lines, and the quantity of scan lines in at least some of the plurality of groups is greater than 1; and
the providing scan signals through the plurality of scan lines includes:
providing scan signals having a same timing to scan lines in a same group.

In some embodiments, the quantity of the plurality of scan lines is M, and M is a positive even number; and
the providing scan signals through the plurality of scan lines; and providing data signals to the plurality of data lines simultaneously through the data chip includes:
providing scan signals with a same timing through an m-th scan line and an (m+1)-th scan line in the plurality of scan lines, and providing data signals to an m-th row of sub-pixels and an (m+1)-th row of sub-pixels simultaneously through the data chip, where m is a positive integer less than or equal to (M−1), and m is an odd number.

In some embodiments, the scan signals are generated according to clock signals, the quantity of clock signals is greater than 2.

In some embodiments, the quantity of clock signals is 4 groups, 8 groups or 16 groups.

In a second aspect, embodiments of the present disclosure provide a display substrate, including: a base substrate and sub-pixel driving circuits arranged on the base substrate; where a plurality of scan lines and a plurality of data lines are arranged on the base substrate, and the scan line and the data line are connected to a corresponding sub-pixel driving circuit; the display substrate further includes a data chip, the data chip includes data output channels, the data output channels are connected to the plurality of data lines, respectively, and the data output channels are in one-to-one correspondence to the plurality of data lines.

In some embodiments, the plurality of scan lines are divided into a plurality of groups along a direction for arranging the plurality of scan lines, the quantity of scan lines in at least some of the plurality of groups is greater than 1, and scan lines in a same group are connected to scan signal terminals which provide scan signals with a same timing.

In some embodiments, the quantity of scan lines is M, M is a positive even number, an m-th scan line and an (m+1)-th scan line in the plurality of scan lines are connected to the scan signal terminals which provide the scan signals having the same timing, where m is a positive integer less than or equal to M−1, and m is an odd number.

In a third aspect, embodiments of the present disclosure provide a display device, including the display substrate as described in any one of the above embodiments.

In some embodiments, the display device is a field sequential liquid crystal display device, and/or the display device is a near-eye display device.

### BRIEF DESCRIPTION OF THE DRAWINGS

To clearly illustrate technical solutions of the embodiments of the present disclosure, a brief description will be given below with reference to the accompanying drawings used in the description of the embodiments of the present disclosure. It is apparent that the drawings in the following description are only some embodiments of the present disclosure, and other drawings can be obtained by a person skilled in the art from these drawings without involving any creative effort.

FIG. 1 is a schematic diagram of a display substrate provided in an embodiment of the present disclosure;

FIG. 2 is a schematic flowchart of a display driving method provided by an embodiment of the present disclosure:

FIG. 3 is a driving timing diagram for the display device provided by an embodiment of the present disclosure; and

FIG. 4 is another driving timing diagram for the display device provided by an embodiment of the present disclosure.

### DETAILED DESCRIPTION

Embodiments of the present disclosure will now be described more clearly hereinafter with reference to the accompanying drawings, in which some, but not all embodiments of the disclosure are described. Based on the embodiments in the present disclosure, all other embodiments obtained by a person skilled in the art in the art without creative effort fall within the scope of the present disclosure.

The terms “first”, “second”, and the like in the embodiments of this disclosure are used for distinguishing similar objects and not necessarily for describing a particular sequential or chronological order. Moreover, the terms “include” and “include”, and any variation thereof, are intended to cover a non-exclusive inclusion, such that a process, method, system, product, or apparatus that includes a list of steps or elements is not necessarily limited to those steps or elements expressly listed, but may include other steps or elements not expressly listed or inherent to such process, method, product, or apparatus. Furthermore, the term “and/or” used in this application means that there is at least one of the associated objects. For example, A and/or B and/or C, refers to seven instances including: A alone. B alone, C alone, and both A and B, both B and C, both A and C, and all of A, B and C.

An embodiment of the present disclosure provides a display substrate.

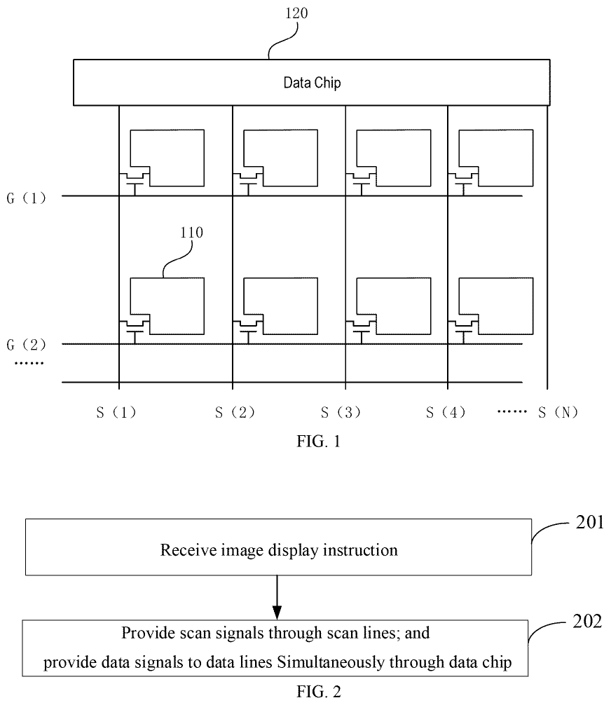

As shown in FIG. 1, in an embodiment, the display substrate includes a base substrate and sub-pixel driving circuits 110 arranged on the base substrate, where a plurality of scan lines G(1) to G(M) and a plurality of data lines S(1) to S(N) are arranged on the base substrate, and the scan line and the data line are connected to a corresponding sub-pixel driving circuit 110.

The display substrate further includes a data chip 120, and in one exemplary embodiment, the data chip 120 may be a display driver IC (DDIC), and the data chip 120 includes a source driver, where the source driver has a plurality of data output channels, and the data output channels are connected to the data lines, and each data output channel is configured for providing a data signal to a data line.

In operation, a switch transistor in each sub-pixel driving circuit 110 is switched on row by row under the control of a scan signal of a scan line, and each data output channel of the data chip 120 is switched on to write pixel data to each sub-pixel driving circuit 110.

It is to be understood that, in the related art, the data chip 120 is connected to data lines through a MUX (Multiplexer), that is, each data output channel corresponds to multiple data lines.

Taking the 1:2 MUX scheme in the related art as an example, each data output channel is connected to two data lines via a MUX switch, and in operation, the MUX switch is firstly controlled to control the data output channel to be connected with one of the two data lines for data writing, and after the data writing is done, the data output channel is controlled to be connected with the other one of the two data lines via the MUX switch. Thus, data writing for the data channel is done. If the data writing time corresponding to each data line is t, the data writing time corresponding to each row of sub-pixels is 2t.

In the technical solution of the embodiment, the data output channels are in one-to-one correspondence to the data lines. In practice, data signals may be provided to the data lines simultaneously via the data output channels. If the data writing time corresponding to each data line is t, the required data writing time is t. Thus, in the technical solution of the embodiment, the data writing time for a single row is reduced to half of the conventional 1:2 MUX scheme, and the data writing time for a single row is reduced to one third of the conventional 1:3 MUX scheme. Apparently, in a case where the sub-pixel charging time is constant, the refresh frequency can also be increased to twice that of the conventional 1:2 MUX scheme, and the refresh frequency can be increased to three times that of the conventional 1:3 MUX scheme.

In some embodiments, the scan lines are divided into a plurality of groups along a direction for arranging the scan lines, the quantity of scan lines in at least some groups is greater than 1, and the scan lines in the same group are connected to scan signal terminals which provide scan signals having a same timing.

In an exemplary embodiment, the quantity of scan lines is M, where M is a positive even number. In the scan lines, an m-th scan line and an (m+1)-th scan line are connected to scan signal terminals which provide scan signals having the same timing, where m is a positive integer less than or equal to M−1, and m is an odd number. It should be noted that in this embodiment, every two scan lines on the display substrate are grouped into a group, so that the two scan lines in each group may obtain scan signals having the same timing.

Each group of scan lines corresponds to the same scan signal. Since the scan signal is generated according to a clock signal. In practice, two paths of clock signals with the same timing may be provided to the scan lines in the same group, or a same single path of clock signal may be provided to the scan lines in the same group. In this way, the sub-pixel driving circuits 110 corresponding to the two scan lines in each group are switched on at the same time; therefore, two rows of sub-pixels corresponding to scan lines in the same group display the same content.

Thus, in the solution of the embodiment, in a case where the time for each scanning is constant, the total scanning time can be reduced, and the overall scanning speed can be increased.

In practice, the quantity of scan lines in each group may be determined according to actual requirements. For example, at the upper edge and lower edge of the display panel, since the requirements for displaying effect are relatively low, scan signals with the same timing are provided to multiple rows of scan lines so as to improve the scanning speed; while for the central region of the display panel, each of rows of scan lines corresponds to a scan signal with a different timing, which can improve the displaying effect at that region.

Illustratively, in an embodiment, 25% of the scan lines near the upper edge and the lower edge of the display panel may be controlled to be scanned in a manner that multiple scan lines have the same scan timing, while 50% of the scan lines located in the central region of the display panel may be controlled to scanned in a manner that each scan line has a different scan timing.

As another example, 25% of the scan lines near the upper edge and the lower edge of the display panel may be controlled to be scanned in a manner that each scan line has a different scan timing, and 50% of the scan lines located in the central region of the display panel may be controlled to be scanned in a manner that multiple scan lines have the same scan timing.

In practice, the scanning manners for different regions of the display panel may be adjusted according to actual requirements, and in the embodiment, the region and range corresponding to different scanning manners are not limited thereto.

An Embodiment of the present disclosure provide a display device. The display device includes the display substrate as described above. In some embodiments, the display device may be a field sequential display device, and in some embodiments, the display device may be a near-eye display device, where the near-eye display device specifically includes but not limited to AR (Augmented Reality) near-eye display device, VR (Virtual Reality) near-eye display device and the like.

Since the technical solution of these embodiments includes all the technical solution of the display substrate provided by the above-mentioned embodiments, at least all the above-mentioned technical effects can be achieved, and the description thereof is omitted here.

Embodiments of the present disclosure further provide a display driving method.

In an embodiment, the display driving method is applied to the display device as described above.

As shown in FIG. 2, in an embodiment, the display driving method includes following steps.

Step 201: receiving an image display instruction.

Step 202: providing scan signals through scan lines; and providing data signals to the data lines simultaneously through the data chip 120, where each of data channels of the data chip 120 provides a data signal to a corresponding data line.

In the technical solution of the embodiment, data output channels are in one-to-one correspondence to the data lines, and in practice, data signals can be provided to the data lines at the same time via the data output channels, respectively.

If the data writing time corresponding to each data line is t, the required data writing time is t. Thus, in the technical solution of the embodiment, the data writing time for single row is reduced to half of the conventional 1:2 MUX scheme, and the data writing time for single row is reduced to one third of the conventional 1:3 MUX scheme. Apparently, in a case where the sub-pixel charging time is constant, the refresh frequency can be increased to twice that of the conventional 1:2 MUX scheme, and the refresh frequency can be increased to three times that of the conventional 1:3 MUX scheme.

In some embodiments, the scan lines are divided into a plurality of groups along a direction for arranging the scan lines, and the quantity of scan lines in each of at least some groups is greater than 1, and the step 202 specifically includes:
providing scan signals having a same timing to scan lines in a same group.

In the embodiment, scan lines in each group corresponds to the same scan signal, since the scan signal is generated according to a clock signal, in practice, two paths of clock signals with the same timing may be provided to the scan lines in the same group, or a same single path of clock signal may be provided to the scan lines in the same group. In this way, the sub-pixel driving circuits 110 corresponding to the two scan lines in each group may be switched on at the same time. As a result, two rows of sub-pixels corresponding to scan lines in the same group display the same content.

Thus, in the solution of the embodiment, in a case where the time for each scanning is constant, the total scanning time can be reduced, and the overall scanning speed can be increased.

In some embodiments, the quantity of the scan lines is M. and M is a positive even number; and the step 202 of providing scan signals through scan lines; and providing data signals to the data lines simultaneously through the data chip 120, includes:
providing scan signals with a same timing through an m-th scan line and an (m+1)-th scan line in the scan lines, and providing data signals to an m-th row of sub-pixels and an (m+1)-th row of sub-pixels simultaneously through the data chip 120, where m is a positive integer less than or equal to (M−1), and m is an odd number.

It should be noted that in this embodiment every two scan lines on the display substrate are grouped into a group, such that the two scan lines in each group correspond to the same scan signal. In practice, sub-pixels in two rows corresponding to the scan lines in the same group displays the same image, and thus, in a case where the time for each scanning is constant, since the total scanning time can be reduced, the overall scanning speed can be increased. Specifically, since the two rows of sub-pixels corresponding to the scan lines in the same group are scanned simultaneously, the total scanning time is equal to one-half of scanning time in conventional art, and the scanning speed can be effectively increased.

In some embodiments, the scan signals are generated from clock signals, and the quantity of clock signals is greater than 2. In some embodiments, the quantity of clock signals may be 4 groups, 8 groups, or 16 groups of clock signals.

In the technical solution of the embodiment, multiple groups of clock signals maybe arranged to provide scan signals, and in practice, the quantity of clock signals can be increased adaptively according to actual requirements and the capability of the data chip 120. As such, with the same scanning frequency, the frequency of a single clock signal can be reduced if the quantity of clock signals is increased, which can reduce power consumption.

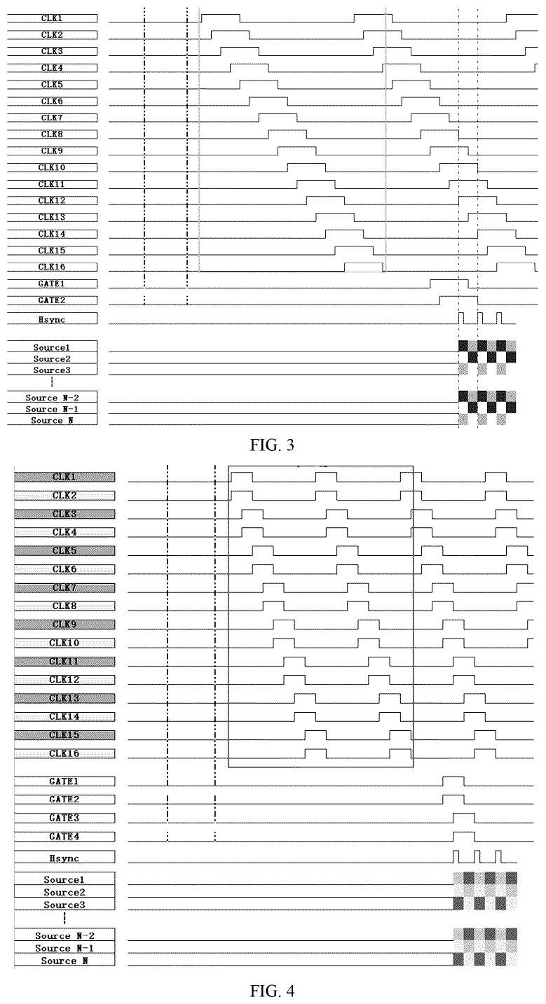

As shown in FIG. 3, FIG. 3 is a driving timing diagram for the display device in an embodiment of the present disclosure, a dummy CLK period may refer to an initialization period when the display device is just turned on, and the dummy CLK period only exists before the first frame of image is displayed when the display panel is turned on.

In this embodiment, 16 clock signals in total, CLK1 to CLK16, are provided. In a case where the scanning frequency is constant, a frequency of a single clock signal can be reduced, which can reduce power consumption.

The scan signals GATE1 and GATE2 are generated according to clock signals, and the timings for the two scan signals are different.

In this figure, Hsync signal is a synchronization signal, and a first rising edge of the Hsync signal corresponds to a starting time instant of a data writing period for a first row of sub-pixels of a first frame image: at this time instant, the scan line for the first row controls sub-pixel driving circuits 110 to switch on, and each of the data channels (Source 1 to Source N, N being an integer greater than 1) writes data to each of the sub-pixel driving circuits 110.

With respect to each data writing period for each data channel, two square grids are illustrated, where each square grid represents a data writing period for one sub-pixel in the 1:2 MUX scheme in the related art. It can be learned that the scanning time for each row of sub-pixels is longer in this embodiment. In practice, the scanning time can be extended according to actual requirement, so as to improve the data writing effect. Apparently, it is also possible to improve the scanning speed if the scanning time is constant, the refresh frequency of the display device can be improved accordingly, which is favorable for improving the displaying effect.

As shown in FIG. 4, a dummy CLK period may refer to an initialization period, which is similar to the embodiment shown in FIG. 3. When compared with the embodiment shown in FIG. 3, the difference lies in that: in this embodiment, the timings of the clock signals CLK1 and CLK2 are the same, the timings of the CLK3 and CLK4 are the same, and so on. In practice, four scan signals in total, GATE1 to GATE4, are generated according to the clock signals, where the scan signals GATE1 and GATE2 have the same timing, and the scan signals GATE3 and GATE4 have the same timing. In practice, two rows of sub-pixels corresponding to the scan lines in the same group have the same scan timing, and therefore, the image displayed by the two rows of sub-pixels are the same.

While the foregoing is directed to exemplary embodiments of the present disclosure, it will be understood by those skilled in the art that various modifications and adaptations may be made without departing from the principle of the disclosure, and such modifications and adaptations fall within the scope of the disclosure.

1. A display driving method, applied to a display device, wherein the display device comprises a base substrate, a plurality of scan lines and a plurality of data lines arranged on the base substrate; the display substrate further comprises a data chip, output terminals of data output channels of the data chip are connected to the plurality of data lines, respectively, and the data output channels are in one-to-one correspondence to the plurality of data lines;
wherein the method comprises:
receiving an image display instruction; and
providing scan signals through the plurality of scan lines; and providing data signals to the plurality of data lines simultaneously through the data chip, wherein each of the data output channels of the data chip provides a data signal to a corresponding one of the plurality of data lines.

2. The method according to claim 1, wherein the plurality of scan lines are divided into a plurality of groups along a direction for arranging the plurality of scan lines, and the quantity of scan lines in at least some of the plurality of groups is greater than 1; and
the providing scan signals through the plurality of scan lines comprises:
providing scan signals having a same timing to scan lines in a same group.

3. The method according to claim 1, wherein the quantity of the plurality of scan lines is M, and M is a positive even number; and
the providing scan signals through the plurality of scan lines; and providing data signals to the plurality of data lines simultaneously through the data chip comprises:
providing scan signals with a same timing through an m-th scan line and an (m+1)-th scan line in the plurality of scan lines, and providing data signals to an m-th row of sub-pixels and an (m+1)-th row of sub-pixels simultaneously through the data chip, wherein m is a positive integer less than or equal to (M−1), and m is an odd number.

4. The method according to claim 1, wherein the scan signals are generated according to clock signals, the quantity of clock signals is greater than 2.

5. The method according to claim 3, wherein the quantity of clock signals is 4 groups, 8 groups or 16 groups.

6. A display substrate, comprising: a base substrate and sub-pixel driving circuits arranged on the base substrate; wherein a plurality of scan lines and a plurality of data lines are arranged on the base substrate, and the scan line and the data line are connected to a corresponding sub-pixel driving circuit; the display substrate further comprises a data chip, the data chip comprises data output channels, the data output channels are connected to the plurality of data lines, respectively, and the data output channels are in one-to-one correspondence to the plurality of data lines.

7. The display substrate according to claim 6, wherein the plurality of scan lines are divided into a plurality of groups along a direction for arranging the plurality of scan lines, the quantity of scan lines in at least some of the plurality of groups is greater than 1, and scan lines in a same group are connected to scan signal terminals which provide scan signals with a same timing.

8. The display substrate according to claim 7, wherein the quantity of scan lines is M, M is a positive even number, an m-th scan line and an (m+1)-th scan line in the plurality of scan lines are connected to the scan signal terminals which provide the scan signals having the same timing, wherein m is a positive integer less than or equal to M−1, and m is an odd number.

9. A display device, comprising:
a display substrate;
wherein the display substrate comprises a base substrate and sub-pixel driving circuits arranged on the base substrate: wherein a plurality of scan lines and a plurality of data lines are arranged on the base substrate, and the scan line and the data line are connected to a corresponding sub-pixel driving circuit; the display substrate further comprises a data chip, the data chip comprises data output channels, the data output channels are connected to the plurality of data lines, respectively, and the data output channels are in one-to-one correspondence to the plurality of data lines.

10. The display device according to claim 9, wherein the display device is a field sequential liquid crystal display device, and/or the display device is a near-eye display device.

11. The display device according to claim 9, wherein the plurality of scan lines are divided into a plurality of groups along a direction for arranging the plurality of scan lines, the quantity of scan lines in at least some of the plurality of groups is greater than 1, and scan lines in a same group are connected to scan signal terminals which provide scan signals with a same timing.

12. The display substrate according to claim 11, wherein the quantity of scan lines is M, M is a positive even number, an m-th scan line and an (m+1)-th scan line in the plurality of scan lines are connected to the scan signal terminals which provide the scan signals having the same timing, wherein m is a positive integer less than or equal to M−1, and m is an odd number.
